(19) United States
(12) Patent Application Publication
(10) Pub. No.: US 2025/0200571 A1
(43) Pub. Date: Jun. 19, 2025

(54) SYSTEM AND METHOD FOR FACILITATING AND VERIFYING OFFLINE DIGITAL ASSET TRANSACTIONS

(71) Applicant: Secretarium Ltd, London (GB)

(72) Inventors: Bertrand Foing, London (GB); Cédric Wahl, London (GB)

(21) Appl. No.: 18/543,310

(22) Filed: Dec. 18, 2023

(51) Int. Cl. G06Q 20/40; G06Q 20/38

(52) U.S. Cl. CPC G06Q 20/401; G06Q 20/389

(57) ABSTRACT

Disclosed is a method for enabling and verifying a chain of offline digital asset transactions. The method involves communication between a first device, a second device, and a trusted third-party device via a communication network. When the communication network is unavailable, the method executes offline digital asset transactions, performing partial verifications using a batched digital signature scheme, storing signature information in a compressed format, and transferring digital assets from the first secure element to the second using pre-stored compressed public keys. Upon network availability, online verification occurs, including the transmission of compressed data to the trusted third-party device for validation. The accumulated value of digital signatures determines the transaction chain's validity, allowing for the identification of valid and invalid offline digital asset transactions. This method ensures secure and efficient offline and online asset transactions.

### TECHNICAL FIELD

The present disclosure relates to methods for enabling and verifying chains of offline digital asset transactions. Moreover, the present disclosure relates to systems for enabling and verifying chains of offline digital asset transactions.

### BACKGROUND

In the field of offline digital payments, various systems have been developed to enable transactions without a need for having constant Internet connectivity. These systems aim to address technical challenges associated with ensuring an authenticity of assets and preventing double-spending while allowing for immediate transfer of consideration. Using offline digital cash, assets or rights involves delaying checks to verify their authenticity, non-replication, and legitimate ownership. One subtype of such use of consecutive offline digital cash/assets enables immediate transfers without the need for having continuous Internet connectivity.

Conventionally, secure elements are used to enhance the security of offline digital transactions. Typically, the secure elements may be implemented as physical chips embedded in devices such as phones, SIM cards, smart cards, and so forth. In this regard, the secure elements are used to safeguard authorization keys, digital payloads, and to provide mutual authentication and fraud detection. However, conventional secure elements are associated with a residual risk of key or payload extraction by technically advanced adversaries, potentially leading to counterfeiting and trust issues arising. Furthermore, the conventional secure elements have associated constraints in terms of memory, computational power, and energy, making it challenging to efficiently verify consecutive offline transactions.

Typically, transactions in offline digital cash systems are stored until the transactions are synchronized with an online ledger, where reconciliation and checks are performed for detecting whether or not counterfeiting or fraud has occurred. This offline storage introduces a risk of counterfeiting and may require additional security measures. Moreover, the risk of double spending cannot be prevented without reliance on an external ledger, which is not always feasible in scenarios lacking constant online Internet connectivity.

Existing state-of-the-art for digitizing consideration-bearer instruments, such as cash, relies on ledgers, wherein there arises in the state-of-the-art implementation challenges due to an ease of copying digital assets compared to physical tokens. Leveraging secure elements to protect digital assets and enable offline settlement is one known approach, but such leveraging carries a risk of hacking and key extraction. Additionally, to address said challenges, a hybrid approach involving secondary checks and data collection has been recommended by central banks. These additional security measures, although beneficial, are hampered by a limited availability of memory of secure elements, thereby posing technical obstacles.

Therefore, in light of the foregoing discussion, there exists a need to overcome the aforementioned drawbacks.

### SUMMARY

An aim of the present disclosure is to provide a method for ensuring security and integrity when carrying out offline digital cash transactions when online verification is not immediately possible or convenient, such as in remote areas or during periods of Internet outage. The aim of the present disclosure is achieved by a method and a system for enabling and verifying a chain of offline digital asset transactions as defined in the appended independent claims to which reference is made. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise. “A method for” may also be expressed as “a method of”.

### BRIEF DESCRIPTION OF THE DRAWINGS

FIG. 1 is an illustration of a flowchart depicting steps of a method for enabling and verifying a chain of offline digital asset transactions, according to an embodiment of the present disclosure; and

FIG. 2 is an illustration of a system for enabling and verifying a chain of offline digital asset transactions, according to an embodiment of the present disclosure.

### DETAILED DESCRIPTION OF EMBODIMENTS

The following detailed description illustrates embodiments of the present disclosure and ways in which they may be implemented. Although some modes of carrying out the present disclosure have been disclosed, those skilled in the art would recognize that other embodiments for carrying out or practicing the present disclosure are also possible.

In a first aspect, the present disclosure provides a method for enabling and verifying a chain of offline digital asset transactions, wherein the method comprises:
receiving, at a trusted third-party device, an initiation of a chain of digital asset transactions from a first device to a second device, wherein the first device, the second device, and the trusted third-party device are communicably coupled to each other via a communication network, and wherein the first device comprises a first secure element, the second device comprises a second secure element, and the trusted third-party device;
detecting, at the first device, whether the communication network is available at a time of the initiation of the chain of digital asset transactions;
when it is detected that the communication network is not available, determining that the digital asset transactions in the chain are offline digital asset transactions and executing the chain of the offline digital asset transactions by:
   performing, at the first secure element, a partial verification of each offline digital asset transaction amongst the chain of offline digital asset transactions, using a batched digital signature scheme and at least one public key that is pre-stored at the first secure element in a compressed form;
   storing, at the first secure element, payload information of a digital signature corresponding to each offline digital asset transaction in a compressed form; and
   transferring a digital asset from the first secure element to the second secure element;
detecting, at the first device, when the communication network is available, upon the execution of the chain of the offline digital asset transactions; and
when it is detected that the communication network is available, upon the execution of the chain of the offline digital asset transactions, performing an online verification for each of the offline digital asset transactions using the trusted third-party device by:
   sending the at least one public key and the payload information that are in the compressed form, from the first secure element to the trusted third-party device; and
   checking, at the trusted third-party device, a validity of each digital signature corresponding to each offline digital asset transaction by:
      determining whether an accumulated value of the digital signatures corresponding to the chain of offline digital asset transactions matches a computed value;
      when it is determined that the accumulated value matches the computed value, identifying an entirety of offline digital asset transactions in said chain as valid; and
      when it is determined that the accumulated value does not match the computed value, identifying one or more offline digital asset transactions in said chain as invalid.

The first aspect of the present disclosure provides the aforementioned method that enhances the security and efficiency of offline digital asset transactions. The method provides a robust mechanism to handle offline transactions by detecting the unavailability of the communication network and seamlessly transitioning to offline execution, ensuring uninterrupted digital asset transactions even in network-disrupted scenarios. Moreover, by performing the partial verification using the batched digital signature scheme and storing compressed payload information, the method optimizes resource usage in secure elements, enabling storage of more transactions with limited memory. This, in turn, reduces the need for frequent online verification, making it particularly 30 suitable for situations where online access is sporadic or impractical.

Furthermore, when the network becomes available again, the online verification process using the trusted third-party device ensures the integrity of the entire transaction chain, preventing counterfeit chains from going undetected. Additionally, by synergistically combining the aforementioned features, the method reduces, for example minimizes, the risk of fraud through efficient verification and immediate detection of counterfeit transactions when back online.

In a second aspect, the present disclosure provides a system for enabling and verifying a chain of offline digital asset transactions, wherein the system comprises:
a first device comprising a first secure element;
a second device comprising a second secure element; and
a trusted third-party device,
wherein the first device, the second device, and the trusted third-party device are communicably coupled to each other via a communication network,
and wherein the trusted third-party device is configured to receive, from the first device, an initiation of a chain of digital asset transactions from a first device to a second device,
further wherein the first secure element is configured to:
   detect whether the communication network is available at a time of the initiation of the chain of digital asset transactions;
   when it is detected that the communication network is not available, determine that the digital asset transactions in the chain are offline digital asset transactions and execute the chain of the offline digital asset transactions, wherein when executing said chain, the first secure element is configured to:
      perform a partial verification of each offline digital asset transaction amongst the chain of offline digital asset transactions, using a batched digital signature scheme and at least one public key that is pre-stored at the first secure element in a compressed form;
      store payload information of a digital signature corresponding to each offline digital asset transaction in a compressed form thereat; and
      transfer a digital asset from the first secure element to the second secure element; and
   detect when the communication network is available, upon the execution of the chain of the offline digital asset transactions, further wherein when it is detected that the communication network is available, upon the execution of the chain of the offline digital asset transactions, the trusted third-party device is configured to:
   perform an online verification for each of the offline digital asset transactions, wherein when performing the online verification, the trusted third-party device is configured to:
      receive, from the first secure element, the at least one public key and the payload information that are in the compressed form; and
      check a validity of each digital signature corresponding to each offline digital asset transaction, wherein when checking the validity, the trusted third-party device is configured to:
         determine whether an accumulated value of the digital signatures corresponding to the chain of offline digital asset transactions matches a computed value;
         when it is determined that the accumulated value matches the computed value, identify an entirety of offline digital asset transactions in said chain as valid; and
         when it is determined that the accumulated value does not match the computed value, identify one or more offline digital asset transactions in said chain as invalid.

The second aspect of the present disclosure provides the aforementioned system that is used to facilitate and verify offline digital asset transactions. The second aspect of the system is capable of providing a versatile and highly secure solution for offline and online digital asset transactions. Moreover, the system seamlessly integrates offline and online capabilities, optimizing resource usage through the use of compressed data, ensuring immediate detection of counterfeits and fraud, and providing unambiguous identification of fraudulent activities. It will be appreciated that the end-to-end security established by the combination of the first secure element in the first device, the second secure element in the second device and the third-party device enhances trust and confidence in the system, making it adaptable to diverse scenarios and resilient against potential threats and fraud, ultimately providing a robust and efficient solution for the digital asset ecosystem.

Throughout the present disclosure, the term “offline digital asset transactions” as used herein refers to a process of exchanging digital assets, such as digital cash, without the need for a constant Internet connection. The digital asset is at least one of, but not limited to a digital currency, a digital art, a digital collectible, a digital media, a digital token, a digital security. In this regard, the offline digital asset transactions enable, parties to transfer the digital assets therebetween when offline, i.e., without being connected to the Internet. In an example, the offline digital asset transactions may occur in settings where Internet access is intermittent or unavailable, such as remote areas, during the Internet outages, or in scenarios where continuous connectivity is not feasible. It will be appreciated that the offline digital asset transactions could be conducted independently of real-time online verification, relying instead on secure elements and subsequent online verification when possible. Herein, enabling and verifying the chain of the offline digital asset transactions means the process of making it possible for a series of digital asset exchanges to occur without the need for a continuous Internet connection, and subsequently ensuring the security, integrity, and authenticity of the offline digital asset transactions. Herein, the phrase “chain of offline digital asset transactions” refers to multiple individual digital transactions that occur between the first device and the second device. Moreover, said phrase must not be miss interpreted in any way with a linear progression of ownership.

The term “first device” as used herein refers to an electronic device that is used by a given user to initiate the chain of the offline digital asset transactions. The term “second device” as used herein refers to another electronic device that is used by another given user to receive the digital assets from the first device. Examples of the first device and the second device include, but are not limited to, smartphones, tablets, laptops, or desktop computers, near field communication (NFC) smartcards, dongles, powered custom devices containing a secure element, point-of-sale devices containing a secure element. Optionally, the communication between the first device and the second device can occur via various means, including but not limited to the NFC, BLE, or any form of the near field communication. For instance, the first device may communicate with the trusted third-party device, intermediated by the second device, or the opposite scenario may also apply. Optionally, the first device and the second device could operate in the same geographical location. Optionally, the first device and the second device could operate in a different geographical location.

The term “trusted third-party device” as used herein refers to a device that is considered reliable, impartial, and secure. In this regard, the trusted third-party device acts as an intermediary or facilitator in the transaction process, ensuring the security and fairness of the transactions between the first device and the second device. The trusted third-party device could be a server implemented as a remote server. In an example, the remote server could be a cloud server that provides a cloud computing service, and could be arranged in a geographical location that is different from the geographical location of the first device and the second device. In other implementations, the server is implemented as a processor of a computing device that is communicably coupled to the first device and the second device. Examples of the computing device include, but are not limited to, a laptop, a desktop, a tablet, a phablet, a personal digital assistant, a server, and so forth.

Notably, the communication network includes a medium (e.g., a communication channel) through which the first device, the second device, and the trusted third-party device communicate with each other. Optionally, the communication network may be a wired or wireless communication network. Examples of the communication network may include, but are not limited to, the Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet. In an example, the first secure element may communicate locally via a near field communication (NFC) or a Bluetooth® low energy (BLE), with the second secure element intermediating the communication.

The term “first secure element” as used herein refers to a hardware component or integrated circuit (such as a processor) located within the first device. The first secure element may be implemented as a processor or chip that safeguards the user's digital assets during transactions. The term “second secure element” as used herein refers to another dedicated hardware component or integrated circuit, located within the second device used by another user to receive the digital assets from the first device. Optionally, the composition of the third-party device may vary, allowing for the inclusion or exclusion of a third secure element. herein, the term “third secure element” refers to the secure enclave located, optionally, within the trusted third-party device. Optionally, the third secure element serves as a tamper-resistant and isolated area within the trusted third-party device, protecting sensitive data and cryptographic operations associated with the digital asset transactions. For instance, the third-party device takes the form of a cluster (namely, a processing unit, a computing unit). Optionally, the trusted third-party device does not require the third secure element when a data center is considered sufficiently cyber-secure and physically secure. This adaptability accommodates diverse security infrastructures while maintaining the essential characteristics necessary for robust offline digital asset transaction security. The characteristics include early counterfeit detection and unambiguous fraud identification.

The trusted third-party device receives the initial request or initiation from the first device to start the chain of the offline digital asset transactions. The initiation could be in the form of a transaction request, a transfer request, or any action that begins the chain of the digital asset transactions.

The method comprises the detection process that takes place on the user's first device. The detection occurs precisely when the first user initiates the transaction chain, ensuring that the communication network availability is evaluated at the time or the moment when the transactions are about to start. In this regard, the first device checks the status of the communication network, looking for indicators that confirm whether or not it is accessible and operational. Moreover, based on the result of this check, the first device is operable to make real-time decisions on how to proceed with the chain of digital asset transactions. The technical effect of the detection is to enable efficient resource allocation and informed decision-making. Furthermore, when it is detected that the communication network is available, the digital asset transactions in the chain would be executed in a conventional manner.

When it is detected that the communication network is not available, the method comprises determining that the digital asset transactions in the chain are offline digital asset transactions. It will be appreciated that the communication network is unavailable, for example, in situations where Internet access is unavailable, unreliable, or temporarily disrupted such as in case of natural catastrophes, in locations where infrastructure reliability is challenging because of economic developments (such as in emerging countries), or in absence of Internet coverage (such as in boats, seas, airplanes, underground, and the like), or due to some geographical constraint (such as islands, mountains, ice, and the like).

When it is detected that the communication network is not available, the method comprises executing the chain of the offline digital asset transactions. In this regard, the chain of the offline digital asset transactions is executed by performing (namely, executing), at the first secure element, the partial verification of each offline digital asset transaction amongst the chain of offline digital asset transactions, using the batched digital signature scheme and at least one public key that is pre-stored at the first secure element in a compressed form. The term “partial verification” as used herein refers to a process of verifying the integrity and authenticity of the transaction without requiring the full transaction data to be available. The term “batched digital signature scheme” as used herein refers to a cryptographic scheme that allows (namely, enables) multiple transactions to be verified with a single signature. Optionally, the batched digital signature scheme possesses the same data footprint as a single signature, and the verification may or may not have the same processing intensity as verifying the single signature.

The first secure element sends the transactions and the signature to the trusted third-party device. When the signature is found to be valid, the trusted third-party device executes the transactions. Moreover, when the public keys in the chain are compressed the first secure element is not able to perform the partial verification. Optionally, when the public keys are non-compressed, then the first secure element can perform the partial verification. In both cases, the first secure element is used to compress the signature received (and verified) with the batch. It will be appreciated that when the compression is non-lossy, then, the partial verification of the chain (as performed in the third-party device) can be performed in the first device and the second device, thus preventing the fraud offline rather than detecting it ex-post.

In the non-lossy compression, the public key is encoded in a manner that facilitates the full re-computation of the public key in the first devices or the second device. An example of the non-lossy compression is storing a portion (e.g., x=256 bits or x+y_parity=257 bits) of a 512-bit public key.

In the lossy compression, the public key undergoes compression through a one-way “hash” function, or a short pseudonymous identifier generated concurrently with the private/public key pair. An example of the lossy compression is a 160-bit Bitcoin address, which is a truncated hash of a 512-bit public key. Optionally, with the lossy compression, the second device requires connection to a device capable of performing the reverse lookup and providing the full key to the trusted third-party device. In such a case, the first device and the second device are unable to access the non-compressed public key when offline, thereby precluding any form of verification independently.

Optionally, the batched digital signature scheme is any one of: a batched-Schnorr signature scheme, a batched Boneh-Lynn-Shacham (BLS) signature scheme, an Edwards-curve digital signature scheme. The term “batched-Schnorr signature scheme” as used herein refers to a batched digital signature scheme that is based on the Schnorr signature scheme. The Schnorr signature scheme is a cryptographic signature scheme that is known for its efficiency and its formally proven security. Moreover, the batched-Schnorr signature scheme allows multiple Schnorr signatures to be generated with the single signature. The batched-Schnorr signature scheme employs (namely, uses) a commitment function to commit to the secret key of the signer, which is the input to the Schnorr signature function. The output of the commitment function is a commitment, which is a publicly verifiable value that is used to verify the Schnorr signature.

The term “batched Boneh-Lynn-Shacham (BLS) signature scheme” as used herein refers to a batched digital signature scheme that is based on the BLS signature scheme. The BLS signature scheme is a cryptographic signature scheme that is known for its short signatures and its fast verification times. Additionally, the BLS signature scheme is known for formal security proof under the Bilinear Diffie-Helman computation hardness assumption. Moreover, the batched-BLS signature scheme allows multiple BLS signatures to be generated with a single signature. The batched-BLS signature scheme employs (namely, uses) a pairing function to pair the public keys of the signers, which are the inputs to the BLS signature function. The output of the pairing function is a pairing, which is a publicly verifiable value that is used to verify the BLS signature. Furthermore, the pairing is a mathematical property of the underlying mathematical group, that makes the decisional Diffie-Helman problem computationally simple.

The term “Edwards-curve digital signature scheme” as used herein refers to a batched digital signature scheme that is based on the Edwards-curve signature scheme. The Edwards-curve signature scheme is a cryptographic signature scheme that is known for its small signatures and its fast verification times. The Edwards-curve digital signature scheme allows multiple Edwards-curve signatures to be generated with a single signature. The Edwards-curve digital signature scheme employs (namely, uses) an Edwards-curve addition function to add the public keys of the signers, which are the inputs to the Edwards-curve signature function. The output of the Edwards-curve addition function is an Edwards-curve point, which is a publicly verifiable value that is used to verify the Edwards-curve signature. The technical effect of using each one of the aforementioned the batched digital signature schemes is to reduce the amount of computation that is required to verify the chain of offline digital asset transactions, which may be important for applications that require fast transaction verification.

It will be appreciated that the Schnorr signature is a digital signature scheme that has the property of being batchable, namely processed in a batch manner. The construction of the Schnorr signature is as below.

Given an elliptic curve (typically NIST secp256r1), its commonly chosen generator G and its order n:

### Key Generation:

A user generates a private key (x) randomly from a large enough space and computes their public key (P) as P=G*x, where G is a generator point on the elliptic curve used in the scheme.

### Signing:

To sign a message (m) (i.e., an offline digital asset transaction), the signer follows these steps:
a. Randomly choose a nonce (k) from a large enough space.
b. Compute the point R=G*k.
c. Compute the challenge (e) as a hash of the message and the x-coordinate of R: e=Hash (m∥R_x).
d. Compute the response(s) as s=k+e*x (mod n), where n is the order of the generator point G.
e. The signature for the message is (R_x, s).

### Verification:

To verify the signature (R_x, s) for the message (m) using the public key P:
a. Compute the challenge (e) as e=Hash (m∥R_x).
b. If G*s=R+P*e, the signature is valid; otherwise, it is invalid.

Here, are the two variants such as variant A and variant B to the Schnorr signature described in the aforementioned text:

Variant A, where the public key is committed during computation of the challenge e=Hash (m∥R_x∥P) used in bitcoin, considered cryptographically safe; everything else remains the same in the construction with the exception of step Verification.b where computation of e is changed accordingly.

Variant B, where R is not committed during computation of the challenge e=Hash (m) or e=Hash (m∥P), and everything else remains the same in the construction with the exception of step Verification.b where computation of e is changed accordingly.

Optionally, said variant is referred to as “Malleable Schnorr”, and is cryptographically *unsafe*, and in practice it is never used. This is because two signatures obtained over two distinct messages M1 and M2 allows a third party to arbitrarily sign any message M3, even without knowing the private key through linearity. Optionally, the malleable Schnorr is employed with the Schnorr accumulator for its footprint optimality under a certain security argument.

The Batched Schnorr signature is an extension of the Schnorr signature that allows multiple signatures to be aggregated into a single signature, significantly reducing the verification time when verifying multiple signatures simultaneously. To create a batched signature:

Follow the signing process for each message separately to obtain individual signatures.
Sum up the individual signatures' R and s components to create the aggregated R′ and s value.

The aggregated signature is represented as (R_x, s_batch).
Verification for the batched signature is performed (namely, executed) in a similar manner as in the standard Schnorr signature, using the aggregated s value and the aggregated point R′ for multiple signatures. Batched Schnorr signatures are useful in scenarios where efficiency and scalability are crucial, as they allow for faster verification of multiple signatures at once.

Alternatively, the Batched Schnorr signature verification is an extension of the Schnorr signature verification that allows multiple signatures over multiple messages signed with different key pairs, to be aggregated into a single signature payload, significantly reducing the signature payload size when verifying multiple signatures simultaneously. To create a batched signature:

Follow the signing process for each message separately to obtain individual signatures.
Draw a random set of barycentric weight (a1 . . . aN)
Sum up the individual signatures' R, s components to create the aggregated R′ and s value, using random barycentric weights (a1 . . . an) with s=Σ(ai*si) and R′=Σ(Ri*ai)

The aggregated signature is represented as (R′, s).
Verification for the batched signature is performed (namely, executed), using the aggregated s′ value and the aggregated point R′ for multiple signatures, with a significant difference as to how the challenge and public key is re used:

Verify the batch as: g*s′=R′+ΣPi*ai*ei

This variant of Batched Schnorr signatures is useful where data footprint of proofs for verification is key, but verification time is greater because of the term ΣPi*ai*ei. This term can nonetheless be computed efficiently using (for instance) the Bos-Coster algorithm.

Optionally, a construction of the Schnorr accumulator retains all “Ri” terms as the chain grows, thus sacrificing payload size (257 bits when using ecc256) for every transaction, in addition to the payload of the public key for each transaction.

Optionally, another construction is further modified by using the malleable Schnorr Signature (alt.B) for proving authenticity of the entire chain with just one {R′,s′} pair, and no additional payload penalty per transaction. It is based on a security argument that “collapsing” all {Ri, si} pairs into the accumulator {R,s} does not expose individual signatures {Ri,si}, and therefore prevents the sort of forgery through linearity that the malleable Schnorr allows when individual signatures are observed.

It will be appreciated that the aforementioned constructions use one-way pseudo-randomly generated barycentric weights (A1 . . . . AN) as per construction below:
(Notations) Assuming a transaction T that transfers N “asset/assetfragments” A1 . . . . AN, drawing respectively quantities Q1 . . . . QN on each of the assets; assuming that Schnorr history accumulators for each of the assets A1 . . . . AN can be noted as Acc_i={Acc_R_i,Acc_s_i}, the transaction T assigning ownership of Q1 of A1, Q2 of A2 . . . . QN of AN to pseudonymous payee Id_payee.

If T is successful, it will result in creation of a digital asset (“asset/asset fragment”), owned by the payee, which will be noted A_t for which Acc_t needs to be computed for the payment chain to continue.

Optionally, a first construction and a second construction are used. In this regard, the first construction is based on non-malleable Schnorr and provides optimum security. Moreover, the second construction is based on Malleable Schnorr and provides optimum footprint.

Transaction T can be serialized as:
T=T_source∥Id_payee∥R in the first construction
T=T_source∥Id_payee∥Nonce in the second construction
Where T_source represents the asset transfers as quantities of each asset and their quantities transferred, which can be serialized as (A1∥Q1)∥ . . . ∥(AN∥QN), with (A1∥Q1) . . . (AN∥QN) ordered by (for instance) their hashes to avoid ambiguity.

Optionally, the Nonce is a number that is used once defined, but can be implicit and constructed as a hash if additional constraints on Q1, Q2, . . . . QN are added.
T_sig_non_malleable=Schnorr_sig(P_payer, message=(T_source∥Id_payee))={R_t,s_t} for the first construction
T_sig_malleable=Malleable_Schnorr_sig(P_payer, message=(T_source∥Id_payee∥Nonce))={R_t,s_t} for the second construction

Id_payee is either a full key public key P_payee, or a non-lossy compression of P_payee, or a shorter loss compression of P_payee, or an Id to be looked up on the trusted third party device.

If T is successful, it will result in creation of a digital asset, owned by payee, which will be noted A_t for which Acc_t needs to be computed as a proof of authenticity if the payment chain is to continue.

Acc_t is computed as:

$$Acc\_t = \{ R\_t , s\_t \} * a\_t + Σ Acc\_i * a\_i$$

Where Acc_i*ai means {Acc_R_i,Acc_s_i}*a_i={Acc_R_i*ai, Acc_s_i*ai} and {R_t,s_t}=T_sig_non_malleable in the first construction, and T_sig_malleable in the second construction.

with (a1 . . . aN) barycenters and a_t being computed as follows:
(1) ai=H(A_i∥Q_i∥Id_payee∥Additional_Info) where H is a chosen one-way function
(2) a_t=1

Optionally, the method employs degraded cryptographic security through other choices of f & g, alternative hashing functions, alternative ways of constructing the nonce. Optionally, the method could select f & g in a way that degrades cryptographic security, alternative ways of building the order (A1 . . . . AN), the addition of metadata, additional information, and so forth.

H can optionally be replaced by any function f with ai=f(A_i,Q_i,Id_payee,Additional_info)
such that:
(1) f is a non-randomized deterministic function, engineered to “look” random under the random oracle model (it is in fact pseudo-random)
(2) It is optionally dependent on Additional_info which may contain T_source,Id_payee,Id_payer,Nonce, and global constants of the system, and may additionally contain R, the Schnorr commitment in the first construction *only*.
(3) It must be one-way function (a hash) of dependent all of inputs A_i,Acc_i,Q_i, Id_payee, Additional_Info (finding {A_i′,Q_i′,Id_payee′, Additional_Info′}< >{A_i,Q_i,Id_payee, Additional_Info} s.t. f(A_i′,Q_i′,Id_payee′, Additional_Info′)=f(A_i,Q_i,Id_payee, Additional_Info)
a_t may be replaced with any (non-zero) deterministic g (A_t) function depending on A_t and global constants of the system.

The new Asset A_t formed by the transaction can be serialized as the adjunction of T_source with T, and proof of asset integrity as Acc_t.

It will be appreciated that usage of the Malleable Schnorr (i.e., the second construction) rather than pure Schnorr (as in the first construction) allows the design to “forget” individual signatures for transactions and eliminate the commitment R from the payload of T, and always reduce the whole set of proofs to a single {R,s}, thus producing a much shorter integrity proof. Moreover, the first construction and the second construction allow another accumulator to be dependent only on arithmetics based on the set of immediately preceding accumulators, and the additional transaction signature, hence the term “Accumulator”. Both the first construction and the second construction also allow “retro propagation” to compute the barycentric weights used in the batch verification.

Verification of the accumulator correctness (on the first device, the second device and the trusted third-party device provided that the payee identifiers are non-lossy, and computational power allowing), based on deterministic retro propagation of all weights affecting each signature. In this regard, the retro propagation refers to the deterministic retroactive computation of weights influencing each signature, challenge, and verification within the chain of transmissions. Beneficially, the retro propagation ensures the verifiability of the entire transaction history. Therefore, each challenge and verification using principles batched Schnorr verification previously described:

If e_1 . . . e_N′ represent the challenge involved in each property transmission in the full chain/tree of transmissions, and w_1 . . . w_N′ associated weights, and if each associated public key P1 . . . . PN′ has been identified, full history can be verified:
when G*s_t=R_t+ΣPi*(e_i*w_i), the accumulator is valid; otherwise, it is invalid.

The EdDSA signature and verification construction is mostly similar to the Schnorr verification, and the construction of the EdDSA accumulator can be inferred from the construction of the Schnorr accumulator. In this regard, the barycentric weights play a pivotal role in achieving the desired aggregation of individual signatures, while using the malleable version of the EdDSA signature.

Given that Nonce is computed from other data (as described above), the system makes the transaction payload lighter by not adding it to the payload. Optionally, a Nonce to the payload is added, possibly a low-entropy one. Alternatively, non-R material (ex: P or other metadata) is used for computation of e.

The Boneh-Lynn-Shacham (BLS) signature scheme is a digital signature scheme based on pairing-based cryptography using a pairing-friendly elliptic curve such as (for instance) BLS12-381. Provided a pairing-friendly group G with generator g, pairing operator e, on two elliptic curve groups G1 and G2 with resp. g1 and g2 as their generators, with e taking its values in G, and H, a hashing operator that takes its values in the second elliptic curve group G2, the construction of BLS may be summarized as follows:

### Key Generation:

A user generates a private key (sk) randomly from a large enough space.

The public key (pk) is computed as pk=g1*sk, where g1 is the generator point of group G1 on an elliptic curve defined over the pairing-friendly group.

### Signing:

To sign a message (m), the signer follows these steps:
a. Compute the hash of the message H (m).
b. Compute the signature as sig=H (m)*sk, where * denotes scalar multiplication in G2.

### Verification:

To verify the signature (sig) for the message (m) using the public key (pk):
a. Compute the hash of the message H (m).
b. Compute the verification point as verify_point=e(pk,H(m)).
c. If verify_point is equal to e(g1, sig), the signature is valid; otherwise, it is invalid.

Batching BLS Signatures: Batching BLS signatures is an efficient way to verify multiple signatures simultaneously. To batch BLS signatures, the individual signatures are simply added up and verification of the aggregated signature takes place in a single step. A method to batch BLS signatures is as follows:

### Signing:

For each message m_i, compute the individual signature sig_i=H(m_i)*sk_i.

### Aggregating:

To create the batched signature, sum up all individual signatures: sig_batch=Σsig_i, where Σ denotes summation in the second elliptic curve group G2.

### Verification:

To verify the batched signature sig_batch for multiple messages m_i using the public keys pk_i:
a. For each message m_i, compute the verification point verify_point_i=e(pk_i,H(m_i)).
b. Compute the aggregated verification point verify_point_batch as Σverify_point_i. where Σ denotes summation in the pairing curve group G.
c. If the pairing equation verify_point_batch is equal to e (g1, sig_batch), then the batched signature is valid; otherwise, it is invalid.

Batching BLS signatures allows for efficient verification, especially when verifying a large number of signatures simultaneously, but also allows saving on storage space.

Moreover, executing the chain of the offline digital asset transactions includes the step of storing, at the first secure element, payload information of the digital signature corresponding to each offline digital asset transaction in a compressed form. The term “payload information” as used herein refers to data that is contained within a digital message. Optionally, the payload information may be the message itself, without any additional headers or metadata. The payload information of the digital signature is the data that is being signed. Optionally, the payload information may be a file (such as a bank statement), or any other type of data. When the communication network is unavailable, the first device must store the payload information of each digital asset transaction in a compressed form. In this regard, the first device employs a compression algorithm to reduce the size of the payload information, thus reducing (for example, minimizing) storage requirements. The compression algorithm must be lossless, ensuring that the original payload information may be perfectly reconstructed from the compressed version. This compressed data is stored securely within the first secure element. This allows the first device to verify the integrity of the transactions when the communication network becomes available. The step of storing ensures data integrity, reduces storage requirements, and facilitates efficient partial verifications even when the communication network is unavailable.

Optionally, the payload information is compressed using an accumulator that is integrated within a framework of the batched digital signature scheme. The term “accumulator” as used herein refers to a short signature payload, resulting from mathematical associative properties of the aforementioned signature schemes, and optionally (in the case of the Schnorr) pseudo-randomness barycenters constructions compatible with maintaining associativity properties. Herein, the framework of the batched digital signature scheme refers to the underlying structure and principles that govern the creation and verification of batched signatures. Optionally, the framework encompasses the cryptographic algorithms, protocols, and data structures employed to generate and validate digital signatures for multiple messages simultaneously. Optionally, for the Schnorr batch signature, the framework encompasses arithmetic to create pseudo-random barycentric weights in a way that does not jeopardize the security of the Schnorr batch verification. The framework defines the overall architecture and operational flow of the batched signature scheme. The specific implementation of the accumulator integration within the batched digital signature scheme may vary depending on the chosen cryptographic algorithms and framework design. Optionally, the integration includes the step of initializing the accumulator to store the payload information of the digital signatures. Optionally, the integration includes the step of generating the batched signature scheme that is used to generate the single signature for multiple messages, ensuring the authenticity and integrity of the transactions. Optionally, the integration includes the step of compressing the payload information of each digital signature using the accumulator.

Optionally, the integration includes the step of updating the accumulator to incorporate the compressed payload information, maintaining the succinctness of the accumulator used for chain integrity verification. Optionally, the integration includes the step of bundling together several such compressed payload information in the process, whilst maintaining the succinctness of the accumulator used for chain integrity verification. Optionally, the integration includes (in the case of Schnorr) the ability to choose the barycenters (a1 . . . aN) pseudo-randomly in a way that maintains the cryptographic security of the batched Schnorr construction whilst leveraging associativity properties for computational efficiency.

Optionally, when the communication network becomes available, the first device can partially verify the offline digital asset transactions using the compressed payload information and the accumulator. Optionally, the private key and the at least one public key are compressed using a data compression technique. It will be appreciated that the compression of the payload information (and the private key and the at least one public key) is performed without compromising any data security.

The term “public key” as used herein refers to a cryptographic key that is used to verify digital signatures and encrypt messages. In other words, the public key is a mathematical value that is derived from a private key, which is a secret key that is known only to the owner of the public key. It will be appreciated that using the pre-stored public key ensures that the digital asset is being transferred to the correct recipient. The public key is used to verify that the recipient of the digital asset is the owner of the corresponding private key. This helps to prevent unauthorized access to the digital asset.

In an implementation, the first secure element generates the digital signature using the private key thereof. The digital signature pertains to the title of property, which assigns a coin or a splinter of a coin, or a group of such splinters from the first secure element to the second secure element. Optionally, the process of signing away several splinters to the second secure element involves a unified approach within the single digital signature. When initiating the transfer, the first secure element generates the digital signature using its private key. Said digital signature encapsulates the information associated with the title of property, which includes the assignment of coins or splinters of coins to the second secure element.

Optionally, the digital signature encompasses the collective information of various splinters being transferred in a single transaction. The details of each individual splinter, such as its unique identifier, ownership attributes, or any other relevant information, are integrated into the overall signed message. Therefore, within the single digital signature, a cohesive representation of the entire group of splinters destined for the second secure element is encapsulated. The second secure element verifies the digital signature using the first secure element's public key. Additionally, the second secure element imports the digital asset therein upon correct verification and computes a new accumulator.

Optionally, upon transferring the digital asset, a redemption of the digital asset or a re-origination of the digital asset occurs at the second secure element (for example, by a second user). In addition to this, the private key is also pre-stored at the first secure element.

The method comprises detecting, at the first device, when the communication network is available, upon the execution of the chain of the offline digital asset transactions. For example, detecting when the communication network is restored, upon the execution of the chain of the offline digital asset transactions. In this regard, the detection is required to verify the validity of the chain of transactions and transfer the digital assets to the second device.

Optionally, the first device can detect when the communication network is available by periodically checking the network status to see if it is available. Optionally, the first device could receive notifications from the communication network when it becomes available. This can be done by registering for network availability notifications or by using other network communication mechanisms.

The term “online verification” as used herein refers to the process of verifying the validity of the chain of offline digital asset transactions using the trusted third-party device after the communication network becomes available. In this regard, the first secure element transmits the compressed or non-compressed public keys and the digital signature payload to the trusted third-party device. The trusted third-party device checks or verifies the validity of each of the offline digital asset transactions. This involves checking the validity of the digital signatures, ensuring that the unique identifiers of the digital assets have not been double spend, and ensuring that the offline digital asset transactions are consistent with the current ledger status. If any discrepancies are identified, the trusted third-party device informs the first device of the problem. Optionally, this includes issues with the validity of the signatures, the uniqueness of the digital assets, or inconsistencies with the ledger status.

Moreover, for the verification to take place, the public keys involved in the entire chain are transferred to the trusted third-party device, either as a pseudonymous “shorter/lossy compressing” form or in “full/non-lossy” format. Optionally, in the event that the “pseudonymous/lossy” form is used, the pseudonym is looked up by the trusted third-party device, implying that the “pseudonym->full format” map is known to the trusted third-party device. Optionally, in the event that the “full/non-lossy”public keys are used, “full” must be understood in the sense that it is sufficient to perform signature verification (example: 257 bits for an ecc256 public key, not the full 512 bits). Optionally, when the “full/non-lossy” public keys be used, the detection of counterfeit can be performed in the first device and the second device.

The term “accumulated value” as used herein refers to a value obtained by summing or aggregating the digital signatures of the individual offline digital asset transactions in the chain. The term “computed value” as used herein refers to a value that can be arithmetically recomputed based on provided payload information. The computed value helps determine whether the chain of offline digital asset transactions is valid or not. The method comprises determining whether or not the accumulated value of the digital signatures corresponding to the chain of offline digital asset transactions matches (namely, cryptographically verifies) the computed value. In this regard, the second device accumulates the accumulated values of the digital signatures corresponding to the offline digital asset transactions in the offline digital asset transactions chain. The trusted third-party device then compares the accumulated value with the computed value. Additionally, if the at least one public key provided is a full key the second secure element, can verify as well. It will be appreciated that the determination of the accumulated values helps to identify if any unauthorized changes have occurred in the chain of offline digital asset transactions.

The method comprises identifying the entirety of offline digital asset transactions in said chain as valid when it is determined that the accumulated value matches the computed value. In this regard, when the accumulated value and the computed value match, the trusted third-party device identifies the entire chain as valid. It will be appreciated that said identification ensures that the entire chain of offline digital asset transactions is trustworthy, and no tampering or fraud has occurred throughout the process.

The method comprises identifying one or more offline digital asset transactions in said chain as invalid when it is determined that the accumulated value does not match the computed value. In this regard, when the accumulated value and the computed value do not match, the trusted third-party device identifies one or more specific transactions within the chain as being invalid. Optionally, in such a case a number of one or more offline digital asset transactions are first flagged as suspicious, and as more evidence is collected, the trusted third-party device can narrow down suspicious one or more offline digital asset transactions until the suspicious one or more offline digital asset transactions are unambiguously attributed. It will be appreciated that said identification provides a safeguard against any unauthorized alterations within the chain, helping to identify which one or more offline digital asset transactions have been affected. Moreover, said identification allows for the isolation and handling of potentially fraudulent or tampered transactions.

Optionally, when the one or more offline digital asset transactions in said chain are identified as invalid, the method further comprises detecting counterfeiting in the one or more offline digital asset transactions using the trusted third-party device, wherein the step of detecting counterfeiting comprises:
analyzing the chain of offline digital asset transactions from a point where a most recent offline digital asset transaction is executed until a point where a first offline digital asset transaction is executed; and
determining a point of divergence where the counterfeiting has occurred, based on said analysis.

The term “counterfeiting” as used herein refers to instances where there is an attempt to create fake or unauthorized digital asset transactions, leading to potential fraud or double spending. In this regard, when the one or more offline digital asset transactions in said chain are identified as being invalid, the method enables the trusted third-party device to examine a transaction log or record for each offline digital asset transaction. The analysis follows a chronological order, moving from the most recent offline digital asset transaction to the first offline digital asset transaction. The term “point of divergence” as used herein refers to the transaction where the legitimate chain splits into two, with one branch representing valid transactions and the other indicating a fraudulent attempt or double spending. The point of divergence is essentially the starting point of the unauthorized or fraudulent activity within the chain of the one or more offline digital asset transactions. In this regard, the trusted third-party device uses pattern recognition or anomaly detection algorithms to spot irregularities. Moreover, during the analysis, the trusted third-party device compares expected and actual transaction data to pinpoint where the chain deviates from the expected behavior.

Optionally, the method further comprises:
receiving, from the first secure element at the trusted third-party device, a request for issuing the digital asset and a payment associated with the digital asset;
issuing the digital asset by the trusted third-party device to the first device, based on said request; and
storing the digital asset by the trusted third-party device at the first secure element.

In this regard, the step of receiving is performed prior to initiating any digital asset transaction from the first secure element of the first device to the second secure element of the second device. The first secure element communicates with the trusted third-party device, conveying the request for issuing the digital asset and payment information associated with the digital asset. The trusted third-party device generates and provides the digital asset requested by the first secure element. The issuance is performed in response to the specific request received from the first secure element. The issued digital asset is then sent to the first device. The trusted third-party device retains a copy of the digital asset and stores it securely at the first secure element. Optionally, the storing includes uploading the digital asset using the trusted third-party device to the first secure element. It will be appreciated that the set of actions ensures a smooth process of handling requests, issuing digital assets, and securely storing them, establishing a foundation for subsequent offline digital asset transactions between the first and second devices.

Optionally, issuance of the digital asset comprises information pertaining to at least one of: a type of the digital asset, an identifier of the digital asset, a quantity of the digital asset, metadata pertaining to the digital asset, an origination signature of the digital asset. In this regard, optionally, issuance of the digital asset comprises information pertaining to the type of the digital asset. The type of the digital asset refers to the category or classification of the digital asset. Advantageously, the type provides essential information about the nature of the digital asset, aiding in proper handling and processing. For example, when the digital asset is the cryptocurrency, the type could be specified as “Cryptocurrency.” Optionally, issuance of the digital asset comprises information pertaining to an identifier that uniquely distinguishes the digital asset from others. Advantageously, the identifier of the digital asset enables precise tracking and identification of the digital asset. For example, the identifier could be a unique alphanumeric code assigned to each digital asset, such as a blockchain address.

Optionally, issuance of the digital asset comprises information pertaining to a quantity of the digital asset which is the numerical amount or volume of the digital asset issued. Beneficially, said information is essential for managing and tracking the quantity of the digital asset in circulation. For example, when issuing the cryptocurrency, the quantity might be specified as “100 units.”

Optionally, issuance of the digital asset comprises information pertaining to the metadata pertaining to the digital asset that is additional descriptive information about the digital asset. Beneficially, the metadata enhances understanding and context, supporting various functionalities. For example, the metadata could include details like the creation date, author, or relevant tags. Optionally, issuance of the digital asset comprises information pertaining to the origination signature of the digital asset that is a cryptographic signature indicating the origin or source of the digital asset. Beneficially, the origination signature of the digital asset provides a secure means to verify the authenticity and source of the asset. For example, a digital signature generated using the private key of the entity issuing the digital asset.

The method ensures that the issuance of the digital asset is not merely a transfer of the asset itself, but includes comprehensive information crucial for proper identification, tracking, and verification. Each piece of information serves a specific purpose, contributing to the overall security and functionality of the digital asset issuance process.

Optionally, when identifying the entirety of offline digital asset transactions in said chain as valid, the method further comprises updating an online transaction ledger using the trusted third-party device, to indicate that a transfer of the digital asset from the first secure element to the second secure element is completed, wherein the trusted third-party device is communicably coupled to the online transaction ledger. Optionally, the trusted third-party device is coupled to an online ownership record.

The term “online transaction ledger” as used herein refers to a digital record or database that securely maintains and tracks a chronological series of offline digital asset transactions conducted over the communication network, typically associated with the digital assets such as cryptocurrencies. In this regard, when identifying the entirety of offline digital asset transactions in said chain as valid, the method updates the online transaction ledger using the trusted third-party device. Moreover, the update in the online ledger indicates that the transfer of the digital asset from the first secure element to the second secure element is completed. It will be appreciated that said updating ensures real-time recording of completed digital asset transfers in the online transaction ledger. The online transaction ledger serves as an immutable record, enhancing trust and reliability in the overall transaction system. The use of the trusted third-party device ensures that the update process is not only automated but also conducted securely, preventing unauthorized modifications.

Optionally, the online transaction ledger is implemented using any one of: a blockchain technology, a Trusted Execution Environment (TEE). The term “blockchain technology” as used herein refers to a decentralized, distributed ledger technology that records transactions across multiple computers in a secure, transparent, and tamper-resistant way. Each transaction forms a “block,” and these blocks are linked in a chain. Optionally, the online transaction ledger is implemented using the blockchain technology. Advantageously, the transactions on the blockchain are transparent and verified through a consensus mechanism. This enhances the trustworthiness of the recorded data. Moreover, once the block is added to the blockchain, it is nearly impossible to alter previous blocks, ensuring the immutability of the transaction history.

The term “Trusted Execution Environment” as used herein refers to a secure and isolated area within a device's hardware where sensitive operations, such as cryptographic processes, can be executed. The TEEs ensure the confidentiality and integrity of data and non-falsifiable processing. Optionally, the TEE ensures that the execution of critical operations, such as updating the online ledger, occurs in a secure and isolated environment, protecting against external threats. Moreover, the TEE provides a secure enclave for sensitive data, ensuring that transaction details are kept confidential and protected from unauthorized access. Furthermore, the TEE guarantees the integrity of the operations within its environment, preventing any compromise during the online transaction ledger update process. Herein, the compromise refers to eavesdropping or falsification.

Optionally, a given secure element is operable to perform an elliptic curve cryptography. It will be appreciated that the given secure element is embedded in a computing device (for example, such as a smartphone, a laptop, a desktop, a tablet, a phablet, or similar), a Subscriber Identity Module (SIM) card, a JavaCard, a smart card, a credit card, a passport, a key ring, a dongle, or similar. The term “elliptic curve cryptography” as used herein refers to a branch of public key cryptography that involves mathematical operations on elliptic curves to provide secure communication and digital signatures. The ECC is chosen for its ability to offer strong security with shorter key lengths compared to other encryption methods, making it efficient for resource-constrained devices. Optionally, the ECC uses the mathematical properties of elliptic curves over finite fields to create cryptographic key pairs. Optionally, the operations such as point addition and scalar multiplication on the ECC curves form the basis of ECC algorithms. In an implementation, the given secure element embedded in the computing devices such as the smartphones, the SIM cards, or the smart cards is equipped with the ability to execute the mathematical operations involved in the elliptic curve cryptography. Amongst the listed batched digital signature schemes above, the batched BLS signature scheme and the Edwards-curve digital signature scheme are based on the ECC, whereas the batched-Schnorr signature scheme could also be adapted to use elliptic curves, though it is not inherently limited to the ECC.

The present disclosure also relates to the system for enabling and verifying a chain of offline digital asset transactions as described above. Various embodiments and variants disclosed above, with respect to the aforementioned method for enabling and verifying a chain of offline digital asset transactions, apply mutatis mutandis to the system for enabling and verifying a chain of offline digital asset transactions.

Optionally, when the one or more offline digital asset transactions in said chain are identified as invalid, the trusted third-party device is configured to detect counterfeiting in the one or more offline digital asset transactions, wherein the step of detecting counterfeiting comprises:
analyzing the chain of offline digital asset transactions from a point where a most recent offline digital asset transaction is executed until a point where a first offline digital asset transaction is executed; and
determining a point of divergence where the counterfeiting has occurred, based on said analysis.

Optionally, the trusted third-party device is configured to:
receive, from the first secure element, a request for issuing the digital asset and a payment associated with the digital asset;
issue the digital asset by the trusted third-party device to the first device, based on said request; and
store the digital asset at the first secure element.

Optionally, issuance of the digital asset comprises information pertaining to at least one of: a type of the digital asset, an identifier of the digital asset, a quantity of the digital asset, metadata pertaining to the digital asset, an origination signature of the digital asset.

Optionally, the batched digital signature scheme is any one of: a batched-Schnorr signature scheme, a batched Boneh-Lynn-Shacham (BLS) signature scheme, an Edwards-curve digital signature scheme.

Optionally, the system further comprises an accumulator configured to compress the payload information, wherein the accumulator is integrated within a framework of the batched digital signature scheme.

Optionally, when identifying the entirety of offline digital asset transactions in said chain as valid, the trusted third-party device is configured to update an online transaction ledger, to indicate that a transfer of the digital asset from the first secure element to the second secure element is completed, wherein the trusted third-party device is communicably coupled to the online transaction ledger.

Optionally, the online transaction ledger is implemented using any one of: a blockchain technology, a Trusted Execution Environment (TEE).

Optionally, a given secure element is capable of performing an elliptic curve cryptography.

### DETAILED DESCRIPTION OF THE DRAWINGS

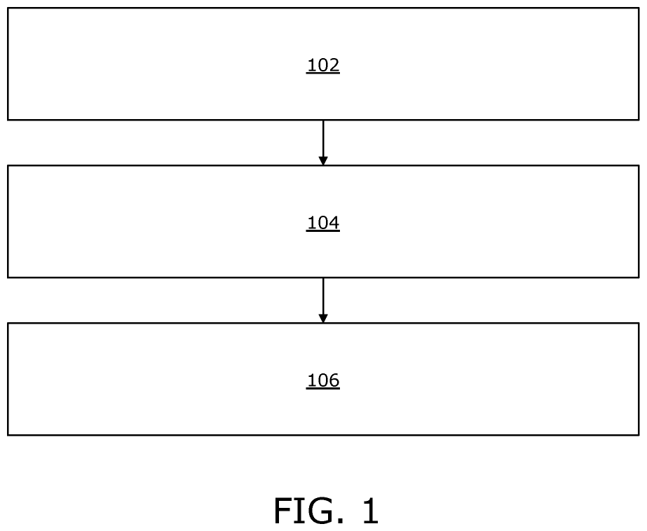

Referring to FIG. 1, there is shown an illustration of a flowchart depicting steps of a method for enabling and verifying a chain of offline digital asset transactions, according to an embodiment of the present disclosure. At a step 102, there is received at a trusted third-party device, an initiation of a chain of digital asset transactions from a first device to a second device, wherein the first device, the second device, and the trusted third-party device are communicably coupled to each other via a communication network, and wherein the first device comprises a first secure element, the second device comprises a second secure element, and the trusted third-party device.

At a step 104, there is detected, at the first device, whether or not the communication network is available at a time of the initiation of the chain of digital asset transactions; when it is detected that the communication network is not available, determining that the digital asset transactions in the chain are offline digital asset transactions and executing the chain of the offline digital asset transactions by: performing, at the first secure element, a partial verification of each offline digital asset transaction amongst the chain of offline digital asset transactions, using a batched digital signature scheme and at least one public key that is pre-stored at the first secure element in a compressed form; storing, at the first secure element, payload information of a digital signature corresponding to each offline digital asset transaction in a compressed form; and transferring a digital asset from the first secure element to the second secure element.

At a step 106, there is detected, at the first device, when the communication network is available, upon the execution of the chain of the offline digital asset transactions; and when it is detected that the communication network is available, upon the execution of the chain of the offline digital asset transactions, performing an online verification, via the communication network, for each of the offline digital asset transactions using the trusted third-party device by: sending the at least one public key and the payload information that are in the compressed form, from the first secure element to the trusted third-party device; and checking, at the trusted third-party device, a validity of each digital signature corresponding to each offline digital asset transaction by: determining whether or not an accumulated value of the digital signatures corresponding to the chain of offline digital asset transactions matches a computed value; when it is determined that the accumulated value matches the computed value, identifying an entirety of offline digital asset transactions in said chain as valid; and when it is determined that the accumulated value does not match the computed value, identifying one or more offline digital asset transactions in said chain as invalid.

The aforementioned steps are only illustrative and other alternatives can also be provided where one or more steps are added, one or more steps are removed, or one or more steps are provided in a different sequence without departing from the scope of the claims herein.

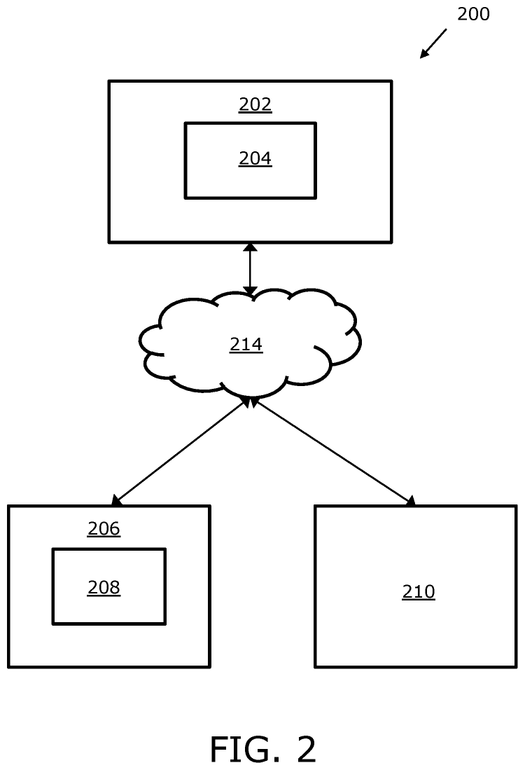

Referring to FIG. 2, there is shown an illustration of a system 200 for enabling and verifying a chain of offline digital asset transactions, according to an embodiment of the present disclosure. The system 200 comprises: a first device 202 comprising a first secure element 204; a second device 206 comprising a second secure element 208; and a trusted third-party device 210, wherein the first device 202, the second device 206, and the trusted third-party device 210 are communicably coupled to each other via a communication network 214.

The trusted third-party device 210 is configured to receive, from the first device 202, an initiation of a chain of digital asset transactions from the first device 202 to the second device 206, further wherein the first secure element 204 is configured to: detect whether or not the communication network 214 is available at a time of the initiation of the chain of digital asset transactions; when it is detected that the communication network 214 is not available, determine that the digital asset transactions in the chain are offline digital asset transactions and execute the chain of the offline digital asset transactions, wherein when executing said chain, the first secure element 204 is configured to: perform a partial verification of each offline digital asset transaction amongst the chain of offline digital asset transactions, using a batched digital signature scheme; store payload information of a digital signature corresponding to each offline digital asset transaction in a compressed form thereat; and transfer a digital asset from the first secure element 204 to the second secure element 208, using at least one public key that is pre-stored at the first secure element 204 in a compressed form; and detect when the communication network 214 is available, upon the execution of the chain of the offline digital asset transactions.

Further, the system 200 is configured such that, when it is detected that the communication network 214 is available, upon the execution of the chain of the offline digital asset transactions, the trusted third-party device 210 is configured to: perform an online verification for each of the offline digital asset transactions, wherein when performing the online verification, the trusted third-party device 210 is configured to: receive, from the first secure element 204, the at least one public key and the payload information that are in the compressed form; and check a validity of each digital signature corresponding to each offline digital asset transaction, wherein when checking the validity, the trusted third-party device 210 is configured to: determine whether or not an accumulated value of the digital signatures corresponding to the chain of offline digital asset transactions matches a computed value; when it is determined that the accumulated value matches the computed value, identify an entirety of offline digital asset transactions in said chain as valid; and when it is determined that the accumulated value does not match the computed value, identify one or more offline digital asset transactions in said chain as invalid.

1. A method for enabling and verifying a chain of offline digital asset transactions, wherein the method comprises:
receiving, at a trusted third-party device, an initiation of a chain of digital asset transactions from a first device to a second device, wherein the first device, the second device, and the trusted third-party device are communicably coupled to each other via a communication network, and wherein the first device comprises a first secure element, the second device comprises a second secure element, and the trusted third-party device;
detecting, at the first device, whether or not the communication network is available at a time of the initiation of the chain of digital asset transactions;
when it is detected that the communication network is not available, determining that the digital asset transactions in the chain are offline digital asset transactions and executing the chain of the offline digital asset transactions by:
performing, at the first secure element, a partial verification of each offline digital asset transaction amongst the chain of offline digital asset transactions, using a batched digital signature scheme and at least one public key that is pre-stored at the first secure element in a compressed form;
storing, at the first secure element, payload information of a digital signature corresponding to each offline digital asset transaction in a compressed form; and
transferring a digital asset from the first secure element to the second secure element;
detecting, at the first device, when the communication network is available, upon the execution of the chain of the offline digital asset transactions; and
when it is detected that the communication network is available, upon the execution of the chain of the offline digital asset transactions, performing an online verification for each of the offline digital asset transactions using the trusted third-party device:
sending the at least one public key and the payload information that are in the compressed form, from the first secure element to the trusted third-party device; and
checking, at the trusted third-party device, a validity of each digital signature corresponding to each offline digital asset transaction by:
determining whether or not an accumulated value of the digital signatures corresponding to the chain of offline digital asset transactions matches a computed value;
when it is determined that the accumulated value matches the computed value, identifying an entirety of offline digital asset transactions in said chain as valid; and
when it is determined that the accumulated value does not match the computed value, identifying one or more offline digital asset transactions in said chain as invalid.

2. The method of claim 1, wherein when the one or more offline digital asset transactions in said chain are identified as invalid, the method further comprises detecting counterfeiting in the one or more offline digital asset transactions using the trusted third-party device, wherein the step of detecting counterfeiting comprises:
analyzing the chain of offline digital asset transactions from a point where a most recent offline digital asset transaction is executed until a point where a first offline digital asset transaction is executed; and
determining a point of divergence where the counterfeiting has occurred based on said analysis.

3. The method of claim 1, wherein the method further comprises:
receiving, from the first secure element at the trusted third-party device, a request for issuing the digital asset and a payment associated with the digital asset;
issuing the digital asset by the trusted third-party device to the first device, based on said request; and
storing the digital asset by the trusted third-party device at the first secure element.

4. The method of claim 3, wherein issuance of the digital asset comprises information pertaining to at least one of: a type of the digital asset, an identifier of the digital asset, a quantity of the digital asset, metadata pertaining to the digital asset, an origination signature of the digital asset.

5. The method of claim 1, wherein the batched digital signature scheme is any one of: a batched-Schnorr signature scheme, a batched Boneh-Lynn-Shacham (BLS) signature scheme, an Edwards-curve digital signature scheme.

6. The method of claim 1, wherein the payload information is compressed using an accumulator that is integrated within a framework of the batched digital signature scheme.

7. The method of claim 1, wherein when identifying the entirety of offline digital asset transactions in said chain as valid, the method further comprises updating an online transaction ledger using the trusted third-party device, to indicate that a transfer of the digital asset from the first secure element to the second secure element is completed, wherein the trusted third-party device is communicably coupled to the online transaction ledger.

8. The method of claim 7, wherein the online transaction ledger is implemented using any one of: a blockchain technology, a Trusted Execution Environment (TEE).

9. The method of claim 1, wherein a given secure element is capable of performing an elliptic curve cryptography.

10. A system for enabling and verifying a chain of offline digital asset transactions, wherein the system comprises:
a first device comprising a first secure element;
a second device comprising a second secure element; and
a trusted third-party device,
wherein the first device, the second device, and the trusted third-party device are communicably coupled to each other via a communication network,
and wherein the trusted third-party device is configured to receive, from the first device, an initiation of a chain of digital asset transactions from a first device to a second device, further wherein the first secure element is configured to:
detect whether or not the communication network is available at a time of the initiation of the chain of digital asset transactions;
when it is detected that the communication network is not available, determine that the digital asset transactions in the chain are offline digital asset transactions and execute the chain of the offline digital asset transactions, wherein when executing said chain, the first secure element is configured to:
perform a partial verification of each offline digital asset transaction amongst the chain of offline digital asset transactions, using a batched digital signature scheme and at least one public key that is pre-stored at the first secure element in a compressed form;
store payload information of a digital signature corresponding to each offline digital asset transaction in a compressed form thereat; and
transfer a digital asset from the first secure element to the second secure element; and
detect when the communication network is available, upon the execution of the chain of the offline digital asset transactions,
further wherein when it is detected that the communication network is available, upon the execution of the chain of the offline digital asset transactions, the trusted third-party device is configured to:
perform an online verification for each of the offline digital asset transactions, wherein when performing the online verification, the trusted third-party device is configured to:
receive, from the first secure element, the at least one public key and the payload information that are in the compressed form; and
check a validity of each digital signature corresponding to each offline digital asset transaction, wherein when checking the validity, the trusted third-party device is configured to:
determine whether or not an accumulated value of the digital signatures corresponding to the chain of offline digital asset transactions matches a computed value;
when it is determined that the accumulated value matches the computed value, identify an entirety of offline digital asset transactions in said chain as valid; and
when it is determined that the accumulated value does not match the computed value, identify one or more offline digital asset transactions in said chain as invalid.

11. The system of claim 10, wherein when the one or more offline digital asset transactions in said chain are identified as invalid, the trusted third-party device is configured to detect counterfeiting in the one or more offline digital asset transactions, wherein the step of detecting counterfeiting comprises:
analyzing the chain of offline digital asset transactions from a point where a most recent offline digital asset transaction is executed till a point where a first offline digital asset transaction is executed; and
determining a point of divergence where the counterfeiting has occurred, based on said analysis.

12. The system of claim 10, wherein the trusted third-party device is configured to:
receive, from the first secure element, a request for issuing the digital asset and a payment associated with the digital asset;
issue the digital asset by the trusted third-party device to the first device, based on said request; and
store the digital asset at the first secure element.

13. The system of claim 12, wherein issuance of the digital asset comprises information pertaining to at least one of: a type of the digital asset, an identifier of the digital asset, a quantity of the digital asset, metadata pertaining to the digital asset, an origination signature of the digital asset.

14. The system of claim 10, wherein the batched digital signature scheme is any one of: a batched-Schnorr signature scheme, a batched Boneh-Lynn-Shacham (BLS) signature scheme, an Edwards-curve digital signature scheme.

15. The system of claim 10, further comprising an accumulator configured to compress the payload information, wherein the accumulator is integrated within a framework of the batched digital signature scheme.

16. The system of claim 10, wherein when identifying the entirety of offline digital asset transactions in said chain as valid, the trusted third-party device is configured to update an online transaction ledger, to indicate that a transfer of the digital asset from the first secure element to the second secure element is completed, wherein the trusted third-party device is communicably coupled to the online transaction ledger.

17. The system of claim 16, wherein the online transaction ledger is implemented using any one of: a blockchain technology, a Trusted Execution Environment (TEE).

18. The system of claim 10, wherein a given secure element is capable of performing an elliptic curve cryptography.
